(19) United States
(12) Patent Application Publication
(10) Pub. No.: US 2016/0219629 A1
(43) Pub. Date: Jul. 28, 2016

(54) Personal Security System

(71) Applicant: Jhih Cheng Liou, TAICHUNG (TW)

(72) Inventor: Jhih Cheng Liou, TAICHUNG (TW)

(21) Appl. No.: 14/605,971

(22) Filed: Jan. 26, 2015

(51) Int. Cl. H04W 76/00; H04M 1/725; G06Q 50/26

(52) U.S. Cl. CPC H04W 76/007; G06Q 50/265; H04M 1/72541

(57) ABSTRACT

In a personal security method, a mobile communication device is used to record sound and images in the vicinity thereof and position information thereof. Then, the sound, images and position information are sent to a remote storage device, and an alert is sent to a control center from the mobile communication device. The control center calls the mobile communication device to determine whether the alert is true or false. If the alert is true, the sound, images and position information are sent to the control center from the remote storage device, and the control center calls a police station to ask the police to approach the mobile communication device to provide rescue. If the alert is false, the personal security method is ended.

### BACKGROUND OF INVENTION

1. Field of Invention

The present invention relates to a personal security system and, more particularly, to a personal security system for taking and transmitting at least one image and GPS information in case of emergency.

2. Related Prior Art

Personal safety can be jeopardized in these days. A person may need help but cannot find any around him or her in emergency. The endangered person can call an acquainted that he or she knows or the police with a cell phone. The endangered person can even take a photograph or a video footage of an attacker and send the photograph to the acquainted with a smart phone. However, the endangered person may not have time to operate the smart phone to do any of these things before he or she is controlled by the attacker in emergency. Hence, the endangered person may not get any help in time to protect him or her from an attack or leave the police any image of the attacker.

Therefore, the present invention is intended to obviate or at least alleviate the problems encountered in prior art.

### SUMMARY OF INVENTION

It is the primary objective of the present invention to provide a personal security method.

To achieve the foregoing objective, the personal security method includes the step of using a mobile communication device to record sound and images in the vicinity thereof and position information thereof. Then, the sound, images and position information are sent to a remote storage device, and an alert is sent to a control center from the mobile communication device. The control center calls the mobile communication device to determine whether the alert is true or false. If the alert is true, the sound, images and position information are sent to the control center from the remote storage device, and the control center calls a police station to ask the police to approach the mobile communication device to provide rescue. if the alert is false, the personal security method is ended.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a simplified diagram of a personal security system according to the first embodiment of the present invention;

FIG. 2 is a flow chart of a method conducted in the personal security system shown in FIG. 1;

FIG. 3 is a perspective view of the cell phone for use in the personal security system shown in FIGS. 1; and

FIG. 4 is a perspective view of a cell phone according to the second embodiment of the present invention.

### DETAILED DESCRIPTION OF EMBODIMENTS

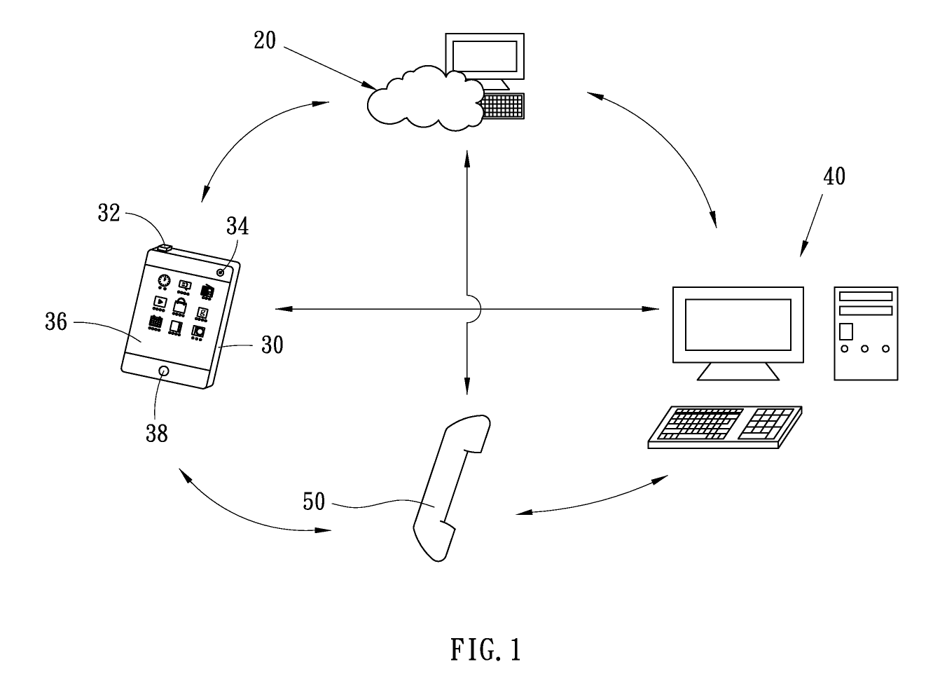

Referring to FIG. 1, a personal security system includes a server 20, a cell phone 30, a control center 40 and a police station 50 according to a first embodiment of the present invention. The cell phone 30 can be replaced with a tablet personal computer or any other mobile communication device. The server 20 is preferably operated in accordance with the Cloud computing. The server 20 is preferably connected to the cell phone 30 and the control center 40 in a wireless manner such as GSM, Bluetooth and infrared. The police station 50 is preferably connected to the control center 40 via telephone lines. The police station 50 is preferably connected to the cell phone 30 in a wireless manner such as GSM, Bluetooth and infrared.

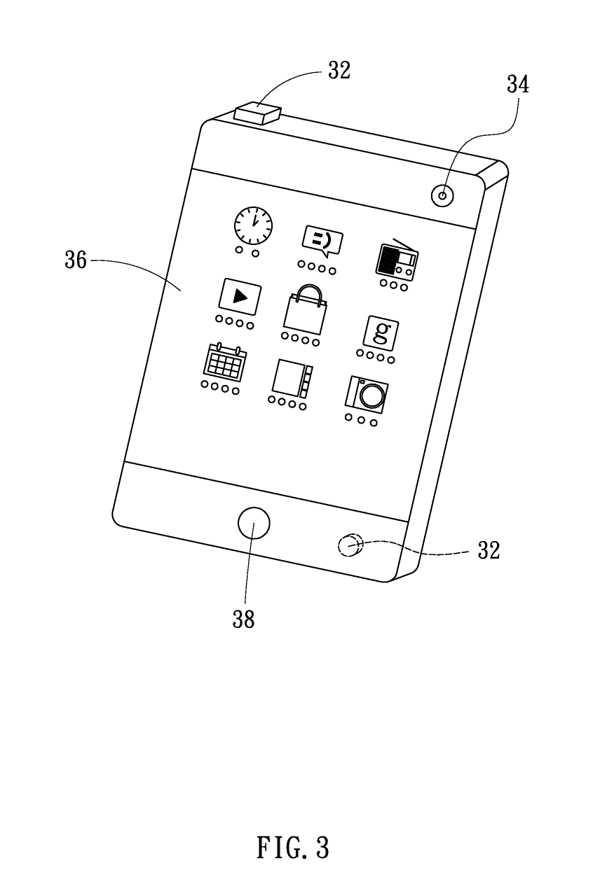

Referring to FIG. 3, the cell phone 30 includes an actuation element 32, an audio-and-video (“AV”) recorder 34, a display 36 and a switch 38. The actuation element 32, the AV recorder 34, the display 36 and the switch 38 are placed on a shell (not numbered). The display 36 is preferably a touch panel. The cell phone 30 is turned on and off by operating the switch 38.

The actuation element 32 can be a button that is located at an upper end of the shell as shown in solid lines or on a front face of the shell as shown in phantom lines. Alternatively, the actuation element 32 can be a universal serial bus (“USB”) storage device that can be inserted in a USB port of the cell phone 30 as shown in phantom lines.

Although not shown, the cell phone 30 further includes a central processor, a transceiver and a global positioning system (“GPS”) unit all of which are placed in the shell. The central processor, the transceiver and the GPS unit are electrically connected to one another. The central processor is electrically connected to the actuation element 32, the AV recorder 34, the display 36 and the switch 38.

The AV recorder 34 includes hardware and software. The hardware of the AV recorder 34 includes a microphone and a camera. The software of the AV recorder 34 includes at least one software program run to convert sound and/or voice taken by the microphone and images taken by the camera into analog or digital files.

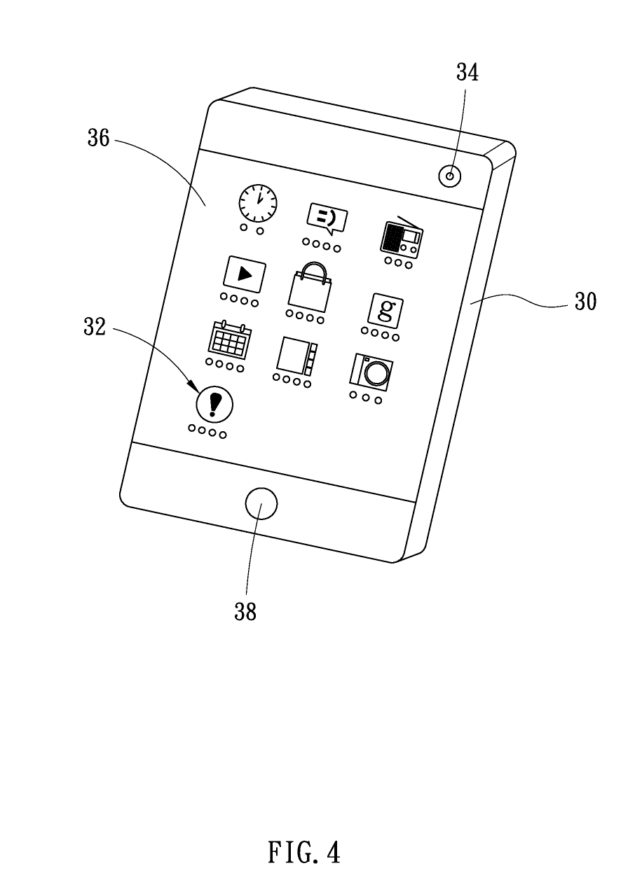

Referring to FIG. 4, there is a cell phone 30 according to a second embodiment of the present invention. The second embodiment is identical the first embodiment except for that the actuation element 32 is an icon on the display 36. To this end, the display 36 must be a touch panel. To create the icon on the display 36, a software program must be run in the cell phone 30 and, more particularly, in the central processor.

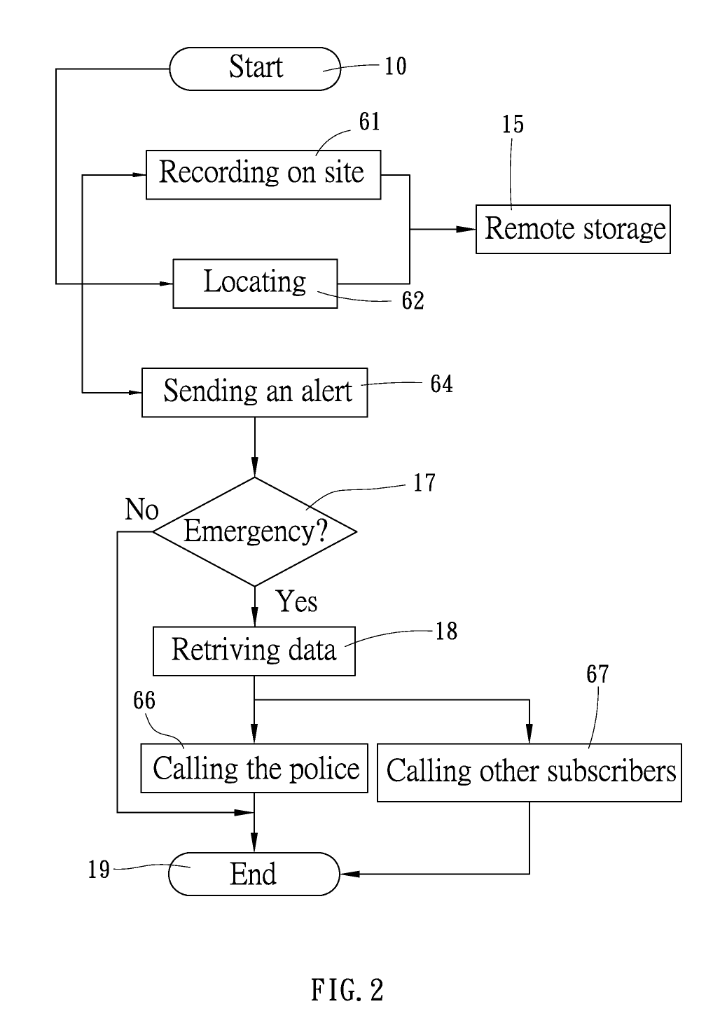

Referring to FIG. 2, at 10, an emergency procedure is initiated by operating the actuation element 32.

At 61, the AV recorder 34 is actuated to take sound and/or voice and images in the vicinity of the cell phone 30.

At 62, the GPS unit is actuated to produce information of the position of the cell phone 30.

At 15, the sound and/or voice and images taken by the AV recorder 34 and the information of the position of the cell phone 30 produced by the GPS unit are sent to and stored in the server 20.

At 64, an alert is sent to the control center 40.

At 17, a person at the control center 40 communicates with the user of the cell phone 30 to determine whether the alert is true or false.

At 19, the process is terminated if the alert is determined to be false.

The process goes to 18 if the alert is determined to be true. At 18, the sound and/or voice and images taken by the AV recorder 34 and the information of the position of the cell phone 30 produced by the GPS unit are sent to the control center 40 from the server 20.

At 66, the person at the control center 40 calls the police at the police station 50. The person at the control center 40 provides the police at the police station 50 with the sound and/or voice and images taken by the AV recorder 34 and the information of the position of the cell phone 30 produced by the GPS unit. The police can find and rescue the user of the cell phone 30 more efficiently with the sound and/or voice and images taken by the AV recorder 34 and the information of the position of the cell phone 30 produced by the GPS unit are sent to and stored in the control center 40 than without.

At 67, the person at the control center 40 notifies another subscriber to the personal security system. The other subscriber may at his or her risk run into the rescue of the user of the cell phone 30.

At 15, the sound and/or voice and images taken by the AV recorder 34 and the information of the position of the cell phone 30 produced by the GPS unit can alternatively be sent to and stored in the control center 40. In this case, the step represented by “18” is omitted.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A personal security method including the steps of:
using a mobile communication device to record sound and images in the vicinity thereof and position information thereof;
sending the sound, images and position information to a remote storage device;
sending an alert to a control center from the mobile communication device;
calling the mobile communication device from the control center to determine whether the alert is true or false;
sending the sound, images and position information to the control center from the remote storage device if the alert is true;
calling a police station from the control center to ask the police to approach the mobile communication device to provide rescue if the alert is true; and
ending the personal security method if the alert is false.

2. The personal security method according to claim 1, further including the step of sending the sound, images and position information to the police station if the alert is true.

3. The personal security method according to claim 2, the step of sending the sound, images and position information to the police station includes the step of sending the same to the police station from the control center.

4. The personal security method according to claim 2, the step of sending the sound, images and position information to the police station includes the step of sending the same to the police station from the remote storage device.

5. The personal security method according to claim 1, further including the step of providing the mobile communication device with:
an actuation element operable to initiate the personal security method; and
an audio-and-video recorder for recording the sound and images.

6. The personal security method according to claim 5, further including the step of providing the mobile communication device with a display operable to initiate the personal security method.

7. The personal security method according to claim 6, wherein the actuation element is a button.

8. The personal security method according to claim 6, wherein the actuation element is an icon.

9. The personal security method according to claim 8, wherein the display is a touch panel.

10. A personal security method including the steps of:
using a mobile communication device to record sound and images in the vicinity thereof and position information thereof;
sending the sound, images and position information to a control center from the mobile communication device;
sending an alert to the control center from the mobile communication device;
calling the mobile communication device from the control center to determine whether the alert is true or false;
calling a police station from the control center to ask the police to approach the mobile communication device to provide rescue if the alert is true; and
ending the personal security method if the alert is false.

11. The personal security method according to claim 9, further including the step of sending the sound, images and position information to the police station from the control center if the alert is true.

12. The personal security method according to claim 10, further including the step of providing the mobile communication device with:
an actuation element operable to initiate the personal security method; and
an audio-and-video recorder for recording the sound and images.

13. The personal security method according to claim 12, further including the step of providing the mobile communication device with a display operable to initiate the personal security method.

14. The personal security method according to claim 13, wherein the actuation element is a button.

15. The personal security method according to claim 13, wherein the actuation element is an icon.

16. The personal security method according to claim 15, wherein the display is a touch panel.
